(19) United States
(12) Patent Application Publication
(10) Pub. No.: US 2020/0138065 A1
(43) Pub. Date: May 7, 2020

(54) PROCESS FOR PRODUCING A FILLER FROM BREWER'S SPENT GRAIN, FILLER, USE OF A FILLER AND FOODSTUFF

(71) Applicant: BÜHLER AG, Uzwil (CH)

(72) Inventors: Carsten PETRY, Winterthur (CH); Mary OLWAL, Winterthur (CH)

(21) Appl. No.: 16/610,545

(22) PCT Filed: May 3, 2018
(86) PCT No.: PCT/EP2018/061393

§ 371 Date: Jan. 14, 2020

(30) Foreign Application Priority Data
May 3, 2017 (EP) 17169345.0

(51) Int. Cl. A23L 7/10; A23L 7/104; A23L 7/117; A23L 2/39; A23L 33/21; A21D 2/36; A21D 13/80; C12F 3/06; C12F 3/10

(52) U.S. Cl. CPC A23L 7/198; A23L 7/104; A23L 7/117; A23L 2/39; A23V 2002/00; A21D 2/368; A21D 13/80; C12F 3/06; C12F 3/10; A23L 33/21

(57) ABSTRACT

A process for producing a filler from brewer's spent grain. The process comprises a) comminuting the brewer's spent grain, b) heating the brewer's spent grain, c) optionally, fermenting the brewer's spent grain, d) optionally, reducing the moisture content of the brewer's spent grain, and e) optionally, mixing the brewer's spent grain with at least one flavor-modifying food additive, such as a sugar substitute(s) and/or an aroma. The brewer's spent grains may be withdrawn from a mash, such as a beer or a barley mash. The comminuting of the brewer's spent grain in step a) may be a milling. Reduction of the moisture content may be effected mechanically, in a first substep d1), and thermally, in a second substep d2). Also disclosed are a filler obtained or obtainable by this process, a use of such a filler and a foodstuff comprising at least one such filler.

This application is a National Stage completion of PCT/EP2018/061393 filed May 3, 2018, which claims priority from European patent application serial no. 17169345.0 filed May 3, 2017.

### FIELD OF THE INVENTION

The invention relates to a process for producing a filler from brewer's spent grain, a filler obtained or obtainable by this process, the use of such a filler and a foodstuff having at least one such filler.

### BACKGROUND OF THE INVENTION

Sugar and/or sugar substitutes are used for sweetening many different foodstuffs.

For the purposes of the present application, sugars are understood to mean the products mentioned in Annex A of Guideline 2001/111/EC of the Council of the European Union of 20 Dec. 2001 relating to certain sugars intended for human consumption, that is to say for example sucrose, invert sugar, glucose, dextrose and fructose.

Within the context of the present invention, “sugar substitutes” are understood inter alia to mean the substances that are listed in Annex 2 to the German regulation relating to the authorization of additives for foodstuffs for technological purposes (German Additive Authorization Regulation of 29 Jan. 1998 (BGB1. I, pp. 230, 231), which was last amended by Article 3 of the Regulation of 21 May 2012 (BGB1. I p. 1201)) (irrespective of the foodstuffs specifically mentioned therein). The term “sugar substitute” therefore encompasses the sugar replacements listed in Part A of the annex mentioned (sorbitol (E 420), mannitol (E 421), isomalt (E 953), maltitol (E 965), lactitol (E 966) and xylitol (E 967)) and the sweeteners listed in Part B of the annex mentioned (acesulfame K (E 950), aspartame (E 951), cyclohexanesulfamic acid (E 952) and the Na and Ca salts thereof, saccharin (E 954) and the Na, K and Ca salts thereof, sucralose (E 955), thaumatin (E 957), neohesperidin (E 959), neotame (E 961) and aspartame and acesulfame salts (E 962)). Furthermore, the term “sugar substitute” also encompasses the sugar replacement erythritol (E 968) and the sweeteners advantame (E 969), steviol glycosides (E 960), polyglycitol syrup (E 964) and lactitol (E 966). The terms “sugar replacement” and “sweetener” are likewise to be understood within this meaning hereinafter.

Artificial sweeteners in particular are very efficient. In comparison to sugar, however, they often take up only a comparatively small portion of the volume for a given effect due to their significantly stronger sweetening power and hence significantly lower dosage in a foodstuff. Therefore, a considerable part of the volume is missing in foodstuffs in which sugar has been at least partially or completely replaced by a sugar substitute. This problem can also arise if in a foodstuff no sugar substitute is used, but instead the sugar content is just reduced.

### SUMMARY OF THE INVENTION

It is thus an object of the present invention to counteract the disadvantages known from the prior art, in particular the above-described disadvantage of the low volume that occurs when using one or more sugar substitutes and/or reducing the sugar content.

A first aspect of the invention relates to a process for producing a filler from brewer's spent grain. Within the context of the present invention, brewer's spent grain is understood to mean the steeped residues of the malt in beer production. A customary beer, brewing process begins with a mashing in which water is heated and coarsely ground malt is added. The resulting beer mash is heated while stirring constantly. When the starch contained in the malt has been sufficiently saccharified, the beer mash is lautered, that is to say the brewer's spent grain is separated from the wort (the liquid, fermentable part of the beer mash). Such brewer's spent grain accumulates in large amounts in the brewery. Brewer's spent grain is therefore a byproduct which rapidly spoils as a result of its high water activity and the high gem load. On account of the abundance of dietary fiber and proteins present, it is generally used as animal feed or processed further, to give animal feed.

The process according to the invention comprises the following steps which are preferably, but not necessarily, performed in this sequence:
a) comminuting the brewer's spent grain,
b) heating the brewer's spent grain,
c) optionally: fermenting the brewer's spent grain,
d) optionally: reducing the moisture content of the brewer's spent grain,
e) optionally: mixing the, in particular dried, brewer's spent grain with at least one flavor-modifying food additive, especially at least one sugar substitute and/or at least one aroma.

The comminution of the brewer's spent grain in step a) is necessary for the further processing and also for the sensory properties in the end product. The heating of the brewer's spent grain in step b) serves for the decontamination and therefore the elimination of in particular pathogenic germs and organisms responsible for spoilage. This is important firstly for the further processing of the brewer's spent grain and secondly for a foodstuff for the production of which the filler is used. The fermentation of the brewer's spent grain in the optional step c) serves for the development of a specific flavor and also for the further stabilization of the product. The optional reduction of the moisture content of the brewer's spent grain in step d) serves for the final stabilization in order to obtain a storage-capable product. In the optional step e), the addition of flavor-modifying food additives such as sweeteners and/or aromas makes it possible to compensate for the sensory quality which is impaired by a reduction in sugar.

The filler produced by the process according to the invention can be used for supplementation purposes in a foodstuff which in particular comprises sugar and/or at least one sugar substitute. In this way it is possible to make up the volume in the recipe for the foodstuff which was reduced for example by the reduction in the sugar content and/or the at least partial replacement of sugar by a sugar substitute. Completely surprisingly, the quality of the foodstuff is not impaired by the addition of the filler obtained by the process according to the invention. Moreover, the process according to the invention permits an additional economical use of the brewer's spent grain besides the use as animal feed. In addition, the process serves for the production of a storage-capable processing form of brewer's spent grain. Furthermore, foodstuffs can be enhanced in terms of nutritional value by means of the use of the filler, since the brewer's spent grain has a relatively high protein and fiber content.

Although DE 390 634 C, EP 0 090 172 A1 and EP 0 609 548 A2 already disclose foodstuffs which are partially produced from brewer's spent grain, a process according to the invention, the filler obtained therefrom and the use thereof do not, however, arise from these documents.

As has already been explained, prior to step a) the brewer's spent grain can be extracted from a mash, and specifically preferably from a beer mash, particularly preferably from a barley mash, in particular from coarsely ground barley malt. This is especially because the barley present in the barley mash is rich in nutritionally important ingredients such as for example dietary fiber and proteins. The malt used for the mash may for example have beers comminuted by means of a hammer mill or preferably by means of a malt mill. It is particularly advantageous when the brewer's spent grain prior to step a) is immediately extracted from the mash and is not for example stored and/or transported in the meantime. The perishability of the brewer's spent grain can be counteracted by means of this.

The comminution of the brewer's spent grain in step a) can comprise a milling. Depending on the sequence of process steps, this may for example be a wet milling or a dry milling. If the milling is effected as the first process step, a wet milling may be performed, for example using a colloid mill. If the milling is effected after the drying, a dry milling is preferably performed, for example using a roller mill.

The particle sizes of the brewer's spent grain after the comminution in step a), in particular after the milling, and prior to the optional reduction of the moisture content in step d), should be between 200 μm and 1600 μm, preferably having an average particle diameter in the range from 250 μm to 500 μm, with preference being given to a relatively narrow particle size distribution and as small as possible an average particle size diameter. The particle size distribution can be ascertained for example using a laser diffraction method known per so.

The milling improves the sensory properties of the filler and boosts fermentation, since the surface area of the particles is increased and thus is more readily accessible to the bacteria performing the fermentation.

The brewer's spent grain in step b) is preferably heated to a temperature which is in the range from 70° C. to 130° C., preferably in the range from 80° C. to 121° C. This temperature is preferably held for a time of from 2 minutes to 120 minutes. The heating step can optionally also comprise at least two heating stages, with a cooling phase being effected between two heating stages which leads to a germination of the spores present in the product. These germinated spores can be inactivated by the following second heating stage. This heating step can alternatively also be effected prior to the comminution, in particular prior to the milling.

Fermentation can preferably be effected in a step c). As an alternative or in addition, fermentation can be performed during at least one, in particular during all other process steps. Fermentation serves to increase digestibility, to enhance the product in terms of sensory properties and also to provide additional stabilization of the brewer's spent grain by suppressing pathogens and organisms responsible for spoilage. Fermentation cars be effected here with yeasts or lacto-bacilli or other bacterial strains. The metabolic products thereof reduce the pH of the brewer's spent grain and lead to the development of a specific flavor.

If the product is not used as a paste, the material is dried in step d). Step d) expediently comprises a first sub-step d1) in which the moisture content of the brewer's spent grain is reduced mechanically. This can by way of example be achieved by pressing the brewer's spent grain, for example using a belt press or screw press. In this way, the moisture content of the brewer's spent grain can be reduced comparatively quickly and easily and the costs of the thermal removal of moisture can be minimized.

The moisture content of the brewer's spent grain immediately after the first sub-step d1) is advantageously in the range from 50% by weight to 70% by weight, preferably in the range from 50% by weight, to 65% by weight, particularly preferably in the range from 50% by weight to 60% by weight.

In order to achieve the final level of moisture, after sub-step d1) or directly without sub-step d1), the moisture content of the brewer's spent grain is preferably reduced by a thermal process, by way of example by means of milling-drying (for example using what is known as a flash dryer) or roller drying. In the case of roller drying, a further milling step should preferably be effected in order to achieve the desired particle sizes.

The moisture content of the brewer's spent grain immediately after step d), in particular after the second sub-step d2), is preferably in the range from 4% by weight to 15% by weight, preferably in the range from 5% by weight to 10% by weight, particularly preferably in the range from 6% by weight to 9% by weight. A moisture content in this range permits storage or transport of the brewer's spent grain in a stable state.

The dried product has particle sizes of 50 μm to 1000 μm, preferably of 100 μm to 800 μm, more preferably of 100 μm to 500 μm, in particular having an average particle size diameter of 100 μm to 300 μm (measured using laser diffraction methods).

The mixing with at least one flavor-modifying food additive, especially at least one sugar substitute and/or at least one aroma, in the optional step e) can take place in a mixer, for example in what is known as a batch mixer.

A further aspect of the invention relates to a filler which was obtained or is obtainable by a process as described above. In particular, such a filler can be intended and developed for supplementing sugar and/or at least one sugar substitute in a foodstuff. This filler exhibits the advantages that have already been described. The filler can for example be present in the form of a powder or of a paste. Within the context of the invention, however, the filler can also be used for purposes other than the supplementation of sugar and/or at least one sugar substitute in the foodstuff.

The invention further relates to the use of the filler for supplementation purposes in a foodstuff, in particular for supplementing sugar and/or at least one sugar substitute in a foodstuff. The filler can in particular be used for supplementing a sugar replacement and/or a sweetener. The advantages of such a use have been set out above.

In yet a further aspect, the invention relates to a foodstuff comprising at least one filler according to the invention. The foodstuff optionally in addition comprises sugar and/or at least one sugar substitute. The at least one sugar substitute which the foodstuff comprises can be at least one sugar replacement and/or at least one sweetener. Such a foodstuff exhibits the advantages already mentioned above.

Particularly advantageously

the proportion of sugar in the foodstuff is at least 2% by weight, preferably at least 3.5% by weight, more preferably at least 5% by weight, particularly preferably at least 7.5% by weight; and/or

the proportion of sugar substitute is at least; 0.06% by weight, preferably at least 0.10% by weight, more preferably at least 0.15% by weight, particularly preferably at least 0.23% by weight; and/or

sugar is present to a proportion of x (in % by weight) and sugar substitute is present to a proportion of y (in % by weight) according to the following formula

$$i . \frac{y}{0.03} + x = z ,$$

ii. wherein z is at least 2% by weight, preferably at least 3.5% by weight, more preferably at least 5% by weight, particularly preferably at least 7.5% by weight.

The foodstuff can be selected from the group consisting of the following foodstuffs:
snacks, in particular cereal bars and snack bars, wherein the snacks may be pressed, fried and/or toasted,
bakery products, in particular bread, crispbread, pastries and waffles, cookies,
patisserie products, such as for example cakes,
breakfast cereals,
sauces,
instant drinks,
pasta, pastes, spreads, fillings.

### BRIEF DESCRIPTION OF THE DRAWING

The invention will be explained in wore detail below on the basis of an exemplary embodiment.

### DETAILED DESCRIPTION OF THE PREFERRED EMBODIMENTS

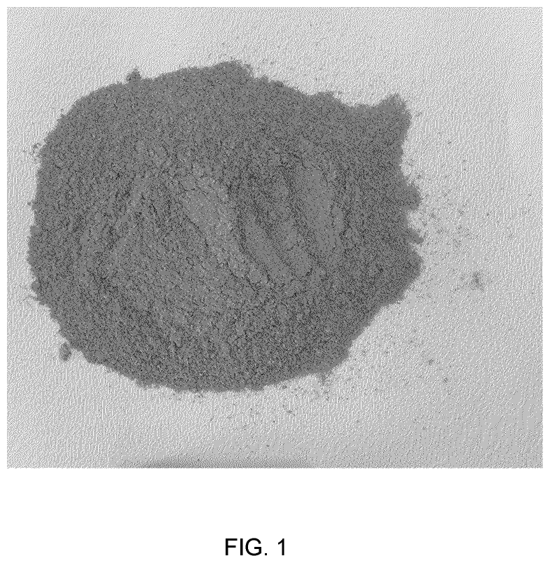

In a beer brewing process that is known per se, brewer's spent grain having a moisture content of approx. 78% by weight was separated after the lautering. This brewer's spent grain was stabilized in a step a) by heating to approx. 100° C. over 5.4 minutes. This was followed in a step b) by a mechanical reduction of the moisture content to approx. 70% by weight and also in a step c) by fermentation using yeast. Subsequently, the material was dried to a moisture content of 6.5% by weight in a thermal drying step d). This material was then comminuted in a step e) using a roller mill and screened using a 0.30 mm screen, whereupon 99.8% by weight of the particles present in the brewer's spent grain had a size of less than 280 μm. FIG. 1 shows the dried powder obtained as a result.

This dried powder was used to produce brewer's spent grain butter cookies from the following recipe: 250 g of butter, 125 g of sugar, 125 g of fermented, dried brewer's spent grain, 250 g of wheat flour, 100 g of eggs, 50 g of water. The butter, water and sugar were firstly mixed for 2 minutes. Next, the eggs were added and the mixture was mixed for 1 minute. After adding flour and brewer's spent grain, the mixture was once again mixed for 1 minute. This resulted in a dough of in total 900 g, which was cooled, rolled out to a thickness of 8 mm, cut out into cookies and baked in a rack oven.

1-18. (canceled)

19. A process for producing a filler from brewer's spent grain, the process comprising the steps of:
a) comminuting the brewer's spent grain, and
b) heating the brewer's spent grain.

20. The process as claimed in claim 19, wherein the process further comprises the steps of:
c) fermenting the brewer's spent grain,
d) reducing a moisture content of the brewer's spent grain, and
e) mixing the brewer's spent grain with at least one flavor-modifying food additive.

21. The process as claimed in claim 20, wherein the steps are performed in a sequence steps a), b), c), d) and e).

22. The process as claimed in claim 19, wherein, prior to step a), the brewer's spent grain is extracted from a mash.

23. The process as claimed in claim 19, wherein the comminution of the brewer's spent grain, in step a), is effected by wet milling, and step b) is performed after step a).

24. The process as claimed in claim 20, wherein the comminution of the brewer's spent grain, in step a), is effected by dry milling, and step b) is performed after step d).

25. The process as claimed in claim 19, wherein the particle sizes of the brewer's spent grain, after step a), are between 200 μm and 1600 μm, and step b) is performed after step a).

26. The process as claimed in claim 19, wherein the brewer's spent grain in step b) is heated to a temperature which is in a range from 70° C. to 130° C.

27. The process as claimed in claim 26, wherein the temperature is held for a duration of time of from 2 minutes to 120 minutes.

28. The process as claimed in claim 20, wherein step d) comprises a first sub-step d1) in which the moisture content of the brewer's spent grain is reduced mechanically.

29. The process as claimed in claim 28, wherein the moisture content of the brewer's spent grain, immediately after the first sub-step d1), is in a range from 50% by weight to 70% by weight.

30. The process as claimed in claim 20, wherein step d) comprises a second sub-step d2) in which the moisture content of the brewer's spent grain is reduced thermally.

31. The process as claimed in claim 20, wherein the moisture content of the brewer's spent grain, immediately after step d), is in a range from 4% by weight to 15% by weight.

32. A filler obtained or obtainable by a process as claimed in claim 19.

33. The filler as claimed in claim 32, wherein the filler has particles having particle sizes of between 50 μm to 1000 μm.

34. A use of a filler obtained or obtainable by a process as claimed in claim 19 for supplementation purposes in a foodstuff.

35. A foodstuff comprising at least one filler obtained or obtainable by a process as claimed in claim 19.

36. The foodstuff as claimed in claim 35, wherein the foodstuff comprises sugar and/or at least one sugar substitute.

37. The foodstuff as claimed in claim 36, wherein the foodstuff has a property selected from the group consisting of:
a proportion of sugar in the foodstuff being at least 2% by weight;
a proportion of sugar substitute(s) being at least 0.06% by weight; and
the sugar being present to a proportion of x% by weight and the sugar substitute(s) being present to a proportion of y% by weight according to the formula
$$\frac{y}{0.03} + x = z$$
z being at least 2% by weight.

38. The foodstuff as claimed in claim 36, wherein the foodstuff is selected from the group consisting of:
snacks,
bakery products,
patisserie products,
breakfast cereals,
sauces,
instant drinks, and
pasta, pastes, spreads, fillings.
